(19) United States
(12) Patent Application Publication
(10) Pub. No.: US 2015/0356637 A1
(43) Pub. Date: Dec. 10, 2015

(54) RETAIL STATION FOR E-DEVICE IDENTIFICATION, ASSESSMENT AND TRADE IN

(71) Applicant: Encore Repair Services, inc., East Dundee, IL (US)

(72) Inventors: Anthony Graffia, II, Inverness, IL (US); Wayne Burg, Simi Valley, CA (US); Sean Flaherty, Hampshire, IL (US)

(21) Appl. No.: 14/731,750

(22) Filed: Jun. 5, 2015

Related U.S. Application Data
(60) Provisional application No. 62/008,949, filed on Jun. 6, 2014.

(51) Int. Cl. G06Q 30/02; G06Q 20/18; G06Q 20/34; G06Q 30/00

(52) U.S. Cl. CPC G06Q 30/0278; G06Q 30/018; G06Q 30/0185; G06Q 20/18; G06Q 20/342

(57) ABSTRACT

A retail station for electronic device evaluation provides a connection interface that supports connection to an electronic device. Software evaluates or provides access to other software to evaluate the electronic device by querying it to collect information to determine its status and value for trade-in. Guidance is provided to aid a customer service representative in processing a trade-in transaction. Data is collected or access is granted to other software to collect data to support a trade-in transaction. Preferred methods of the invention use a station in the form of a tablet or countertop devices. The methods guide and facilitate a trade in in a retail environment, while checking data to ensure that the electronic device does not have an unclean status and providing assistance in assessing value of the electronic device. A system provides a third party the ability to support retail trade in transactions for value.

### PRIORITY CLAIM AND REFERENCE TO RELATED APPLICATION

The application claims priority under 35 U.S.C. §119 from prior provisional application Ser. No. 62/008,949, which was filed Jun. 6, 2014.

### FIELD

A field of the invention is electronic device identification and assessment. An example preferred application of the invention is to trade-in and retail transactions involving such devices.

### BACKGROUND

When retailers accept returns of e-devices from their customers, there are several areas of risk. The first is the proper identification of the device by their employee accepting the return. If the device is misidentified, a retailer runs the risk of giving too high of a credit or refund to the customer. This can prevent returns to the manufacturer, or lower the retailer's revenue when liquidating returned goods.

After identification, a separate risk to the retailer concerns a customer activated anti-theft locking mechanism, commonly called “Activation Lock.” An activation lock renders an e-device, such as a smart phone, worthless to any person other than the original owner. If an activation lock is discovered after a customer leaves, the retailer may not be able to locate the customer to disable the anti-theft activation lock. One current example of that is Apple's “Find my iPhone” feature.

Another retailer risk concerns the customer's personal data. This data can include contacts, passwords, credit card information, photos, videos, etc. If this data is not properly erased, this exposes the retailer to potential liability. Improper handling of the customer's personal data can lead to monetary and reputational damage.

Yet another retailer risk concerns accepting a device that has been reported stolen to a carrier or law enforcement database that tracks stolen mobile devices. If a retailer buys or accepts a return on such a device they have very little recourse to recover the funds.

Retailers nonetheless have a desire to accept trade-ins of e-devices. Trade-in value for electronic devices can help generate additional sales and revenues for retailers. Retailers benefit from easy-to-use programs that draw customers into physical stores and encourage the purchase of new electronic devices. Providing on-the-spot trade-in value for a prior device promotes new sales in a similar manner to the trade-in services offered by car dealers.

Third parties compete for the trade-in value of modern portable electronic devices. There are numerous business that purchase and re-sell used smart phones and tablets. These include online retailers that offer to purchase used smart phones and tablets. A typical web retailer provides a quote range that depends upon the type of device, the communication standard of the device (GSM or CDMA), and some basic condition information. These businesses thrive despite significant inconveniences to the consumer, who must fill out forms, package and ship the device, and then wait a period of time while the device is being evaluated before receiving payment for the device. Often the actual price eventually offered the consumer is significantly less than an initial estimate. As the consumer has lost possession of the device, the consumer often accepts what is likely a less than used market value for a device, rather than attempting the restart the process or incur shipping and handling charges, as well as further inconveniences. These on-line used phone purchase businesses represents a lost opportunity for traditional electronics retailers that provide physical locations and sales support.

ecoATM has introduced a kiosk style device that is sized like an automated teller machine or a DVD vending machine. This device is the subject of US published patent application no 20130046699, which was published on Feb. 21, 2013. The kiosk device encourages recycling electronic devices, and provides instant cash for turning in a used device. A number of steps are required to trade in a device, and the time delays associated with the device trade-in can be discouraging to consumers. A consumer must select a plug-in for the device, is photographed by the kiosk, and must present identification that is read by the kiosk. Some consumers are discouraged by these steps, from a practical and privacy standpoint. Practically, consumers that have difficulty with basic device functions can find the steps required to use the kiosk confusing. Submitting to photographs and ID scanning can be off-putting from a privacy perspective, and particularly with respect to a kiosk that is similar to a vending machine. The kiosk also relies upon information from secondary market partners. While a consumer receives value information much more quickly with the kiosk compared to on-line vendors, the value information is also likely to be less than true used market value. The kiosk therefore represents an additional dilution of value from the consumer's perspective because the kiosk is an additional party taking a share of the value. Nonetheless, instant cash for trade-ins is a strong lure to consumers. The kiosks represent another lost opportunity for traditional electronics retailers.

Traditional electronics retailers have emphasized recycling programs. In the recycling programs, consumers can bring used devices into the stores and sometimes receive some (often nominal) compensation for the devices. These programs help to draw consumers into the stores, but mainly through pressure to act in an environmentally friendly manner. Most consumers are aware of the environmental hazard posed by used electronic devices, and the in-store programs provide consumers a convenient location to responsibly rid themselves of old devices. This market started when handsets had many unique operating systems, were simpler a less powerful devices, and failed to retain any significant value. While it does bring consumers into a traditional electronic retailer locations, the act of recycling is not intimately connected with the purchase of a new device. Many consumer collect low value old electronics at home and eventually dump a batch at a recycling center. This represents a lost opportunity to traditional retailers, in that the consumers may not seek to trade-in/trade-up a device, instead collecting a box of old devices to eventually recycle through one of these recycling programs.

Some retailers have begun to emphasize trade in programs to help drive new device sales. Unlike the on-line buyers of used phones, the retailers are not afforded the luxury of time to make an evaluation. Consumers often exhibit strong impatience at the point of sale in a traditional retail store. As a result, retailers must assess an electronic device on-the-spot. Some stores include machines in the back rooms that aid in this evaluation. An example machine is iCapture32. This machine identifies a mobile device by accessing the electronic identification data on the device itself (e.g. model, generation, serial number, firmware version, etc.). This machine is unable to perform any other functions beyond basic identification. Also, the machine is very bulky and separate from the point of sale of a new replacement device, which is conducted through the store's traditional transaction terminal. The terminal can itself be a tablet computer.

### SUMMARY OF THE INVENTION

An embodiment of the invention is a retail station for electronic device evaluation. The station provides a connection interface that supports connection to at least one type of electronic device. Evaluation software evaluates or provides access to other software to evaluate the electronic device by querying the electronic device to collect information determine its status and value for a trade-in transaction. Guidance software generates information to aid a customer service representative in processing a trade-in transaction of the electronic device. Data collection software collects data or grants access to other software to collect data to support a trade-in transaction. In preferred embodiments, the station includes a base sized to be on a retail countertop. In preferred embodiments, the station is realized with software on a tablet computer that includes the connection interface. Preferred embodiments provide guidance and support to check the clean or unclean status of the electronic device, and for supporting operations such as reset and wipe of the electronic device.

A preferred method for identifying, assessing and facilitating trade in of electronic devices includes connecting an electronic device to a station in a retail environment. Checking is conducted for anti-theft feature activation on the electronic device and instructions for shutting down any activated anti-theft features are displayed on a display. Unique electronic device identification data is obtained and compared to database information of unclean device identifications. An indication that the electronic device can't be processed is displayed if a unclean device status is found. Otherwise, collection of device conditions is guided through the display and device conditions are received. Valuation information is displayed through the display based upon received device conditions. In preferred embodiments, the display includes providing images of the type of electronic device and information on how to evaluate the electronic device. Preferred embodiments include wiping data from the electronic device. Preferred embodiments include displaying an acceptance screen upon the display and obtaining and storing transaction confirmation data. Preferred embodiments obtain biometric data that is sufficient to meet requirements of applicable Second Hand Dealer laws. Preferred methods are implemented upon a retail station computer device running software that interfaces with the electronic device and accesses a server over the Internet. The server can be administered by a party that provides the retail station and support to the retail location in exchange for value. Preferred embodiments include generating gift card information to the station and storing records regarding the gift card information. Preferred embodiments include generating a unique device identification and printing a label through the station to apply to the electronic device for tracking of the electronic device.

A preferred system for facilitating trade in of electronic devices includes a retail station at a retail location with a connection capability to connect to a plurality of types of electronic devices. A display is associated with the retail station for displaying guidance and instructions during a trade in transaction including valuation and exchange information. A label printer is associated with the retail station for printing labels to affix to electronic devices or packaging of electronic devices for processing by a third party. A server associated with the third party is configured to communicate with the retail station, obtain device information from a device connected to the retail station, provide the guidance and instructions based upon a type of device that is connected to the retail station, check the clean or unclean status of the device connected to the retail station, provide the valuation and exchange information based upon an assessed device condition and type, and direct printing of a label with a unique device identification for processing by the third party when the retail location sends an electronic device to the third party.

### BRIEF DESCRIPTION OF THE DRAWINGS

FIG. 1 illustrates steps executed by a preferred embodiment retail station during evaluation of an electronic device;

FIGS. 2A-2H are a flowchart of operations performed by a retail device evaluation system implemented with a retail station of a preferred embodiment in the form of a tablet;

FIG. 3 is schematic diagram of a preferred embodiment retail station module;

FIG. 4 is a schematic diagram of a preferred embodiment retail system of the invention; and

FIG. 5 is a schematic diagram of another preferred embodiment retail system of the invention.

### DETAILED DESCRIPTION OF THE PREFERRED EMBODIMENTS

An embodiment of the invention is a retail station for electronic device identification and assessment. “Retail” is used broadly herein, and includes standard retail locations such as electronics stores and phone and data carrier outlets, but also can includes any location in which value can be exchange for an electronic device. As an example, schools often provide students with electronic devices to use during a limited period. The evaluation upon return can determine whether the user receives a deposit credit or some other type of value. This can be considered a retail transaction within the meaning of this description. “Station” as used herein includes specially configured retails units with processors and software for performing retail trade in transactions in accordance with the invention and general purpose tablet computers including such software for performing retail trade in transactions.

Preferred retail stations include software and interfaces to other software via network, Internet or other connections for performing functions of: disabling any activation locks, erasure of all customer personal data, checking of electronic device information, particularly unique information such as the commonly used ESN (electronic serial number), IMEI (international station equipment identity) and MEID (mobile equipment identifier) identification numbers against databases of known stolen devices, and facilitation of trade-in transactions. The station evaluates portable electronic devices. Preferred embodiments evaluate smart phones, e.g. iPhones®, Android®, and Windows® phones, tablet computers and MP3 Players. In preferred embodiments, the station is a physical countertop device that includes code. The station includes at least one port, and more preferably includes one to four ports. More ports can be used, but practical value at a retail point of sale is likely to favor 1-4 ports. In other embodiments, the station is a tablet computer that includes a touch screen and port for connecting to devices.

A preferred embodiment retail station can provides guidance and access to identify and disable manufacturer or carrier activation locks, secure erasure of customer personal data, and verify identification numbers against known stolen devices on publically available databases populated by law enforcement, carriers or others with reliable data.

In other embodiments the retail station is created by code run on a multi-purpose device used in a retail location, such as a computer terminal or tablet computer. The software including retail station functions of the invention provides a new device to facilitate electronic device commerce at retail locations. The tablet connects to a device to be traded in, such as through a USB, micro USB, or other connector and connects to other software and databases through an Internet connection. A preferred tablet running software of the invention includes one or more adapters to connect the tablet to a variety of common mobile electronic devices.

In other embodiments, the retail station is a stand-alone device. This avoids the need for a retailer to integrate the retail station on an existing system, and provides for quick set-up and use. Sales/implementation cycles are reduced as there is no need to involve retailer/corporate IT departments in the initial set-up and use of a retail station of the invention.

In any form, the station includes or accesses evaluation software. The evaluation software can obtain data from electronic devices necessary for the evaluation of the device. Upon an evaluation, a rating can be provided to a retailer. The retailer, through an on-site customer service representative can then offer a trade-in value to encourage a purchase at the point of sale. The software facilitates also transfer of the device, e.g. data wipe, de-activation, etc. The station also preferably includes guidance software that guides the retail customer service representative through the process to facilitate a transaction. The guidance software can provide instructions concerning technical issues and value issues. The guidance software can also assist in resolving issues that might prevent a transaction if the evaluation software determines that a problem exists that could prevent a transaction.

Preferably, the station also includes software to interface with the retailer's retail transaction and accounting system. The station can also include an identification acceptance screen, e.g., a magnetic signature. A signature acknowledging the sale of the electronic device(s) being traded in can be stored with information concerning the transaction. Similarly, a tablet running software of the invention can accept a signature on a touch screen.

Preferred software can evaluate or provide access to other software that can access the locked/unlocked status of a phone or another device. The software can also evaluate physical aspects of the phone, such as battery health, screen condition, and case condition. The software can run many types of diagnostic tests or provide messages to other software to enable running the diagnostic tests. The evaluation software can also, for example, access databases that track stolen devices or databases that indicate contract status with data or phone service provider network.

In addition to evaluation software and functions the station can also run or provide access to software to “wipe” the phone when instructed to do so by a customer or a retail customer service representative as part of a transaction involving a trade in and purchase of a replacement device.

Preferred stations of the invention interface with a client's inventory and accounting systems, to facilitate proof of sale of the trade-in device and condition at the time of the transaction, along with other device specific identification details.

Preferred stations of the invention can rely upon Carrier and Law Enforcement databases that track reports of stolen devices to avoid illegitimate transactions. It can also rely on a on an evaluation formula for trade-in pricing.

Preferred stations of the invention are configured to be conveniently used at physical retail stores. Specific preferred physical station configurations consistent with the preferred embodiments include a small footprint, multiple USB ports to connect to various mobile devices, the ability to access the internet via cellular networks over a locally sourced cellular hotspot, and I/O via a tablet computer (e.g. Apple iPad or Samsung Galaxy Tab) by pairing a Bluetooth signal or WiFi signal, generated by the invention acting as a Wifi router. In one preferred embodiment, the station is a compact and attractive all in one package that can be physically assembled on site with the tablet attached by a hinging system so it can be in an angled position when in use and flat on the top of the device when not in use and a plastic receiver for a cellular mobile hotspot (e.g. Verizon Jetpack 4G LTE MiFi).

Those knowledgeable in the art will appreciate that embodiments of the present invention lend themselves well to practice in the form of computer program products. Accordingly, it will be appreciated that embodiments of the present invention may be realized with computer program products including computer executable instructions stored on a non-transitory computer readable medium that, when executed, cause a computer to undertake methods according to the present invention, or a computer configured to carry out such methods. The executable instructions may include computer program language instructions that have been compiled into a machine-readable format. The non-transitory computer-readable medium may be, by way of example, a magnetic, optical, signal-based, and/or circuitry medium useful for storing data. The instructions may be downloaded entirely or in part from a networked computer. Also, it will be appreciated that the term “computer” as used herein is intended to broadly refer to any machine capable of reading and executing recorded instructions. It will also be understood that results of methods of the present invention may be displayed on one or more monitors or displays (e.g., as text, graphics, charts, code, etc.), printed on suitable media, stored in appropriate memory or storage, etc.

An embodiment of the invention is a retail station for electronic device evaluation. The station provides a connection interface that supports connection to at least one type of electronic device. Evaluation software evaluates or provides access to other software to evaluate the electronic device by querying the electronic device to collect information determine its status and value for a trade-in transaction. Guidance software generates information to aid a customer service representative in processing a trade-in transaction of the electronic device. Data collection software collects data or grants access to other software to collect data to support a trade-in transaction. In preferred embodiments, the station includes a base sized to be on a retail countertop. In preferred embodiments, the station is realized with software on a tablet computer that includes the connection interface. Preferred embodiments provide guidance and support to check the clean or unclean status of the electronic device, and for supporting operations such as reset and wipe of the electronic device.

A preferred method for identifying, assessing and facilitating trade in of electronic devices includes connecting an electronic device to a station in a retail environment. Checking is conducted for anti-theft feature activation on the electronic device and instructions for shutting down any activated anti-theft features are displayed on a display. Unique electronic device identification data is obtained and compared to database information of unclean device identifications. An indication that the electronic device can't be processed is displayed if a unclean device status is found. Otherwise, collection of device conditions is guided through the display and device conditions are received. Valuation information is displayed through the display based upon received device conditions. In preferred embodiments, the display includes providing images of the type of electronic device and information on how to evaluate the electronic device. Preferred embodiments include wiping data from the electronic device. Preferred embodiments include displaying an acceptance screen upon the display and obtaining and storing transaction confirmation data. Preferred embodiments obtain biometric data that is sufficient to meet requirements of applicable Second Hand Dealer laws. Preferred methods are implemented upon a retail station computer device running software that interfaces with the electronic device and accesses a server over the Internet. The server can be administered by a party that provides the retail station and support to the retail location in exchange for value. Preferred embodiments include generating gift card information to the station and storing records regarding the gift card information. Preferred embodiments include generating a unique device identification and printing a label through the station to apply to the electronic device for tracking of the electronic device.

A preferred system for facilitating trade in of electronic devices includes a retail station at a retail location with a connection capability to connect to a plurality of types of electronic devices. A display is associated with the retail station for displaying guidance and instructions during a trade in transaction including valuation and exchange information. A label printer is associated with the retail station for printing labels to affix to electronic devices or packaging of electronic devices for processing by a third party. A server associated with the third party is configured to communicate with the retail station, obtain device information from a device connected to the retail station, provide the guidance and instructions based upon a type of device that is connected to the retail station, check the clean or unclean status of the device connected to the retail station, provide the valuation and exchange information based upon an assessed device condition and type, and direct printing of a label with a unique device identification for processing by the third party when the retail location sends an electronic device to the third party.

Preferred embodiments of the invention will now be discussed with respect to the drawings. The drawings may include schematic representations, which will be understood by artisans in view of the general knowledge in the art and the description that follows. Features may be exaggerated in the drawings for emphasis, and features may not be to scale.

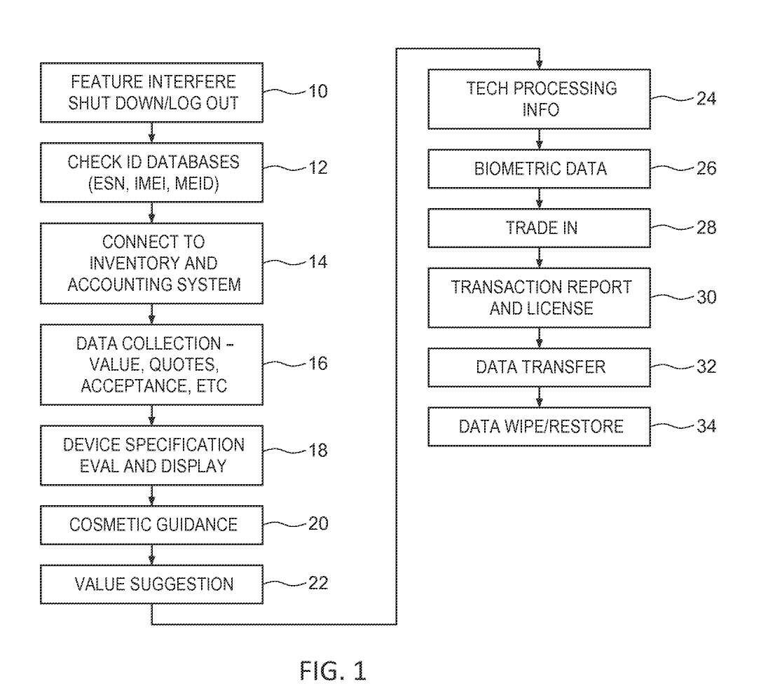

A FIG. 1 method for e-device evaluation can be implemented on one or more devices that run or access software. In some embodiments, a retail station is implemented across a plurality of devices. For example, a physical interface and connection might be provided to connect to electronic devices. A retail customer service representative might use a separate computer, such as a tablet computer, to communicate with the device interface via a wireless network interface. The device interface acts as a server and the tablet computer as a client. Similarly, the device interface and wired network interface might communicate through a wired LAN network. In other embodiments, the interface communicates via a wide area network. In this case, the customer service representative may be on-site or may be presented virtually to a customer that is on-sight. With control of the interface, the steps necessary for a customer to trade in a device can be completed, and the device itself or a separate computer can assist. In some embodiments, the station is wholly implemented on a tablet device and the tablet connects physically or wirelessly with an electronic device being evaluated.

FIG. 1 illustrates steps executed by a preferred embodiment retail station, which may be countertop device or may be a tablet running software. Whether in a physical countertop device or run on another computer or tablet device that aces as a retail station, the preferred functions performed by code on specific preferred embodiment can include instructions to guide a retail assistant and/or a customer. The steps guide the evaluation and trade-in processes.

For example, a display can present a customer and/or the retail customer service representative/clerk with basic initial instructions. For example, the user can be instructed to shut down or log out 10 of features that can interfere with transfer and re-activation of the device. For example, the Apple® iOS7 includes a Find my Phone feature. This feature must be turned off to facilitate transfer of the device. Preferred embodiments address these types of anti-theft device issues. Many electronic devices have methods built into them or added to them to prevent or deter theft of the device. Preferred stations detect or enable other software (such as through an Internet connection) to detect the implementation and activation of anti-theft technology on devices. The retail customer service representative is prompted to request the customer to remove the anti-theft protection from the device. Detecting the anti-theft technology at the collection point prevents receiving a device that is economically without value or a device that may have been stolen, and the detection of the anti-theft protections helps to avoid such a circumstance.

The software also checks or provides access or information to other software to check publicly maintained electronic device identification databases 12, to guard against accepting devices that are stolen or otherwise ineligible for processing and resale. For example, for a phone, the retail station can check ESN (electronic serial number), IMEI (international mobile equipment identity) and MEID (mobile equipment identifier) data to insure that the phone can be transferred. Preferred embodiments also provide for integration, or connectivity with, customer inventory and/or accounting systems 14, e.g. an ERP (enterprise resource planning) or RMS (retail management system), to process transactions and entitle gift cards or store credits. The station can also collect data 16 to report on quotes generated, acceptance, failed quotes, unknown units, and other information that might be useful on going forward basis. The retail station can also assist a retail customer service representative in determining and displaying 18 the type of electronic device to be processed and the device specifications. This can include, for example, confirmation of hardware version, battery testing, memory checking and the like.

Preferred stations provide a charging capability to a connected device. A device brought to a retailer may lack enough battery capacity remaining to perform evaluations and operations necessary to facilitate a trade in transaction. This deficient state is recognized and a fast charge is automatically applied to the device. A preferred retail station includes a fast charge that is achieved using the maximum amperage permitted by the device's internal charging circuit. Preferred retail stations can provide, for example, a 2 Amp current for fast charging, instead 1 Amp used during a typical charging operation. The retail customer service representative is notified by the station of the condition and an estimate of the time remaining before the transaction can continue. In some cases, the transaction can continue while charging begins and the electronic device will be included in the process at the moment it is able.

The retail station can also assist a retail customer service representative in determining a cosmetic condition 20 of the device. This can be guided, for example, with the retail station providing instructions or images to compare the device to or with the retail station imaging portions of the device and conducting an analysis of the images. The guidance may include quantity of scratches and blemishes, surface scars, general wear and tear, and other criteria. The guidance may be in the form of a checklist, or implemented with visual examples. In other embodiments, the device is imaged and inspected electronically for condition.

The station can provide a value suggestion 22. This can be through a standard analysis using secondary market information. The station could alternatively use algorithms developed based upon sales or resale information or demand or other information useful in setting prices based upon data from a retailers system.

The station can also provide technical information 24 specific to particular device to aid a retail customer service representative in processing the device. This can direct the representative, for example, to change device settings, enter device codes or network codes, etc. Preferred embodiments thus assist in device identification both electronically and visually. A connected device is queried to retrieve identity information and other information such as the memory capacity of the device, the processor used by the device, the operating system used by the device and other available information. In addition to electronic information retrieved from the device a physical description and visual identification aid are provided to visually identify the device. The retail customer service representative is guided in determining if the visual identification is consistent with the electrical identification, or the device can be electronically assessed with imaging technology. Preferred embodiments correlate the collected electronic device data and cosmetic data to determine a remuneration value for the electronic device. The remuneration value may be determined according to a table of remuneration values indexed on device type and quality, the remuneration value may be determined through a quantitative analysis of cosmetic, functional, and model type values, or the remuneration value may be a fixed value. The value tables can also be updated according to retailer information or retailer settings.

Preferred embodiments capture transaction details and/or communicate such details to retailer transaction systems and/or to retail station support, informatics and analytics database. Example details can include device information, cosmetic condition, model type, customer information, date, time, location, and other information is collected into a database. This information can be made available for reporting and analysis of transactions. This information can also be used to generate return Certificates of Erasure to the customer and for fulfilling Second Hand Dealer reporting requirements. For example, the station can perform functions to act as an endpoint for the collection of data from a customer for the purposes of complying with second hand dealer laws, providing certificates of erasure, business data collection, and to be an endpoint for the dissemination of operational data, such as device identification data, remuneration value data, and other data necessary to assist a retail customer service representative in the trade of remuneration for a used electronic device.

The station can also collect of assist a retail customer service representative in collecting biometric information 26 from a customer. The level of information collected can preferably be adjusted, and may include, for example, merely collecting a signature. Other retail locations may prefer to obtain more biometric information. For example, preferred embodiments collect and store biometric information about the customer. This information can include, for example, a scan of the customer's driver license, a picture of the customer's driver license, the right thumbprint of the customer, an electronic photograph of the customer, and the customer signature. Customers are more likely to continue with collection of such information during a transaction in a retail environment, and also to provide information with the presence of a customer service representative to guide the transaction. The biometric data can be collected to comply with Second Hand Dealer laws. The data is also collected as a deterrent to fraudulent transactions, a deterrent to the selling of stolen devices, as proof of authority to sell the device, and as proof of intent to sell the device. The retail customer service representative is guided through the process of collection of this information from the customer, such as via displayed instructions. A customer signature can also be obtained. A camera can be used to take an image of the customer or identification of the customer. Preferred embodiments aid compliance with second hand dealer rules. Various jurisdictions have a requirement to validate the legal ability of a person to trade real property for some remunerative value. These requirements are generally known as Second Hand Dealer laws. The compliance required by Second Hand Dealer laws varies from jurisdiction to jurisdiction. Generally, the laws will require the customer to identify themselves and to leave a unique indicator of who they are such as a thumb or finger print. The station guides the retail customer service representative through the collection of the customer information required by the local jurisdiction by collecting data that is specific to the local jurisdiction. Minimum requirements are met, but the station can also optionally collect more than is required. The station can also produce a contract to support the sale and an acknowledgement of an intent to perform the transaction. The acknowledgement generally is recognized as the customer's signature confirming the transaction.

Preferred embodiments also include computerized business methods that use a station of the invention as a licensed station to a retailer, and the license is based upon a percentage of trade-in value or per device transaction fee. A service provider provides retailers with retail stations, in the form of physical devices or software added to other computer devices, at nominal or at no charge, and the service provider collects fees based upon the value or number of transactions processed by the licensed station. Upon completion of a trade-in 28 transaction, information can be provided 30 as part of a license between a retailed and a service provider that licensed the station. In other embodiments, the retailer provides a one-time payment or license.

Preferred embodiments also provide data transfer 32 as a part of a trade-in and new device purchase. Specifically, the station can transfer customer data from one device to another device or allow other software to conduct the transfer, with both devices being connected. Alternatively, data can be temporarily stored, and then transferred to a new device. The data transferred can include calendars, phone books, and email from one device to another. In addition to data, the device can transfer applications (apps) and accounts from one device to another.

Preferred embodiments provide a device erasure 34, or “wipe” feature via built in software or by access to other software. All personal information on an electronic device is deleted. A restore feature can also be provided as part of the erasure that restores device settings to factory settings. This preferably includes removing non-private data that was not present at the time of original sale and restoring missing items that were present at the time of initial sale.

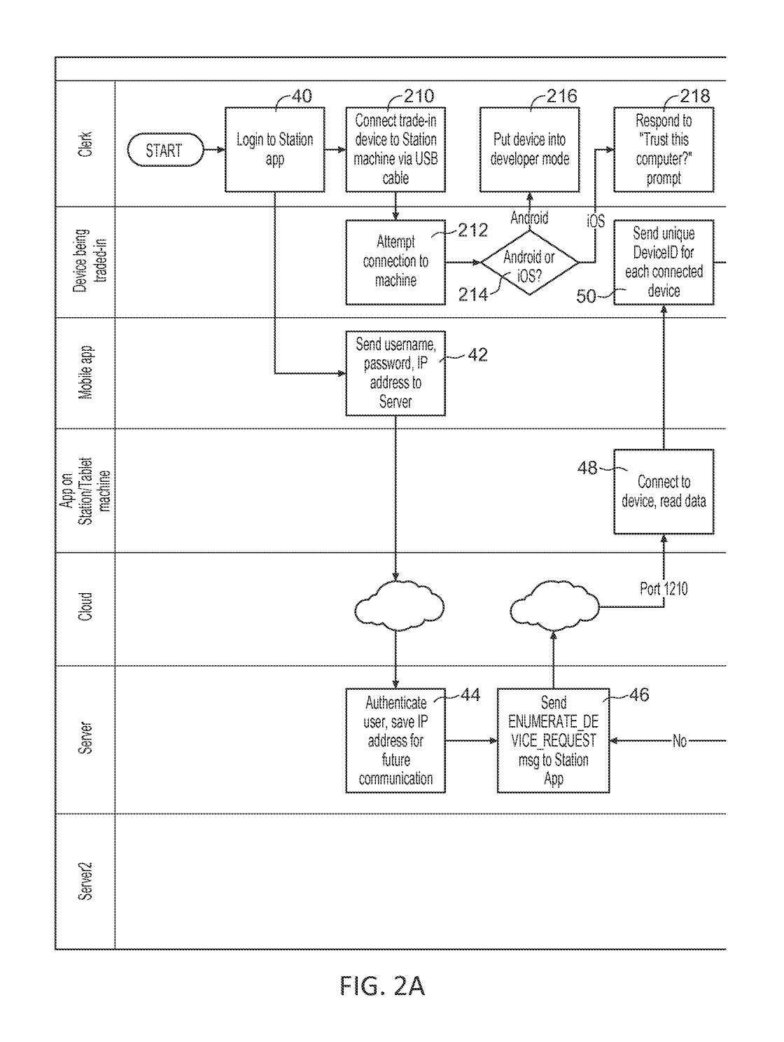

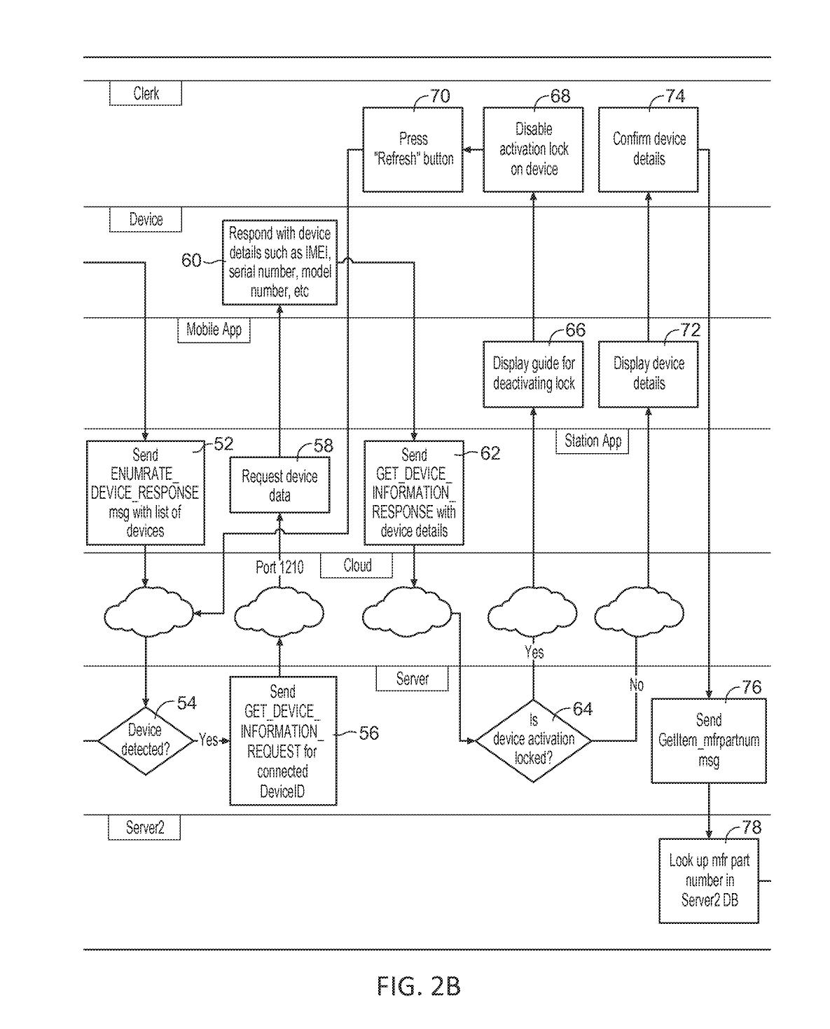

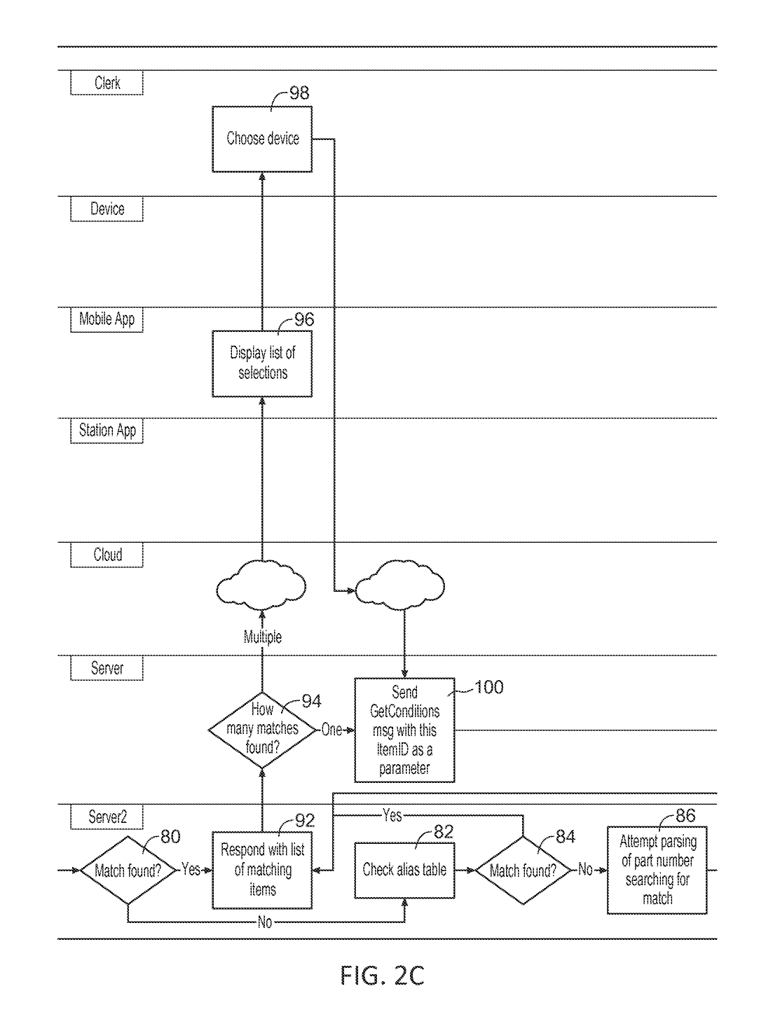

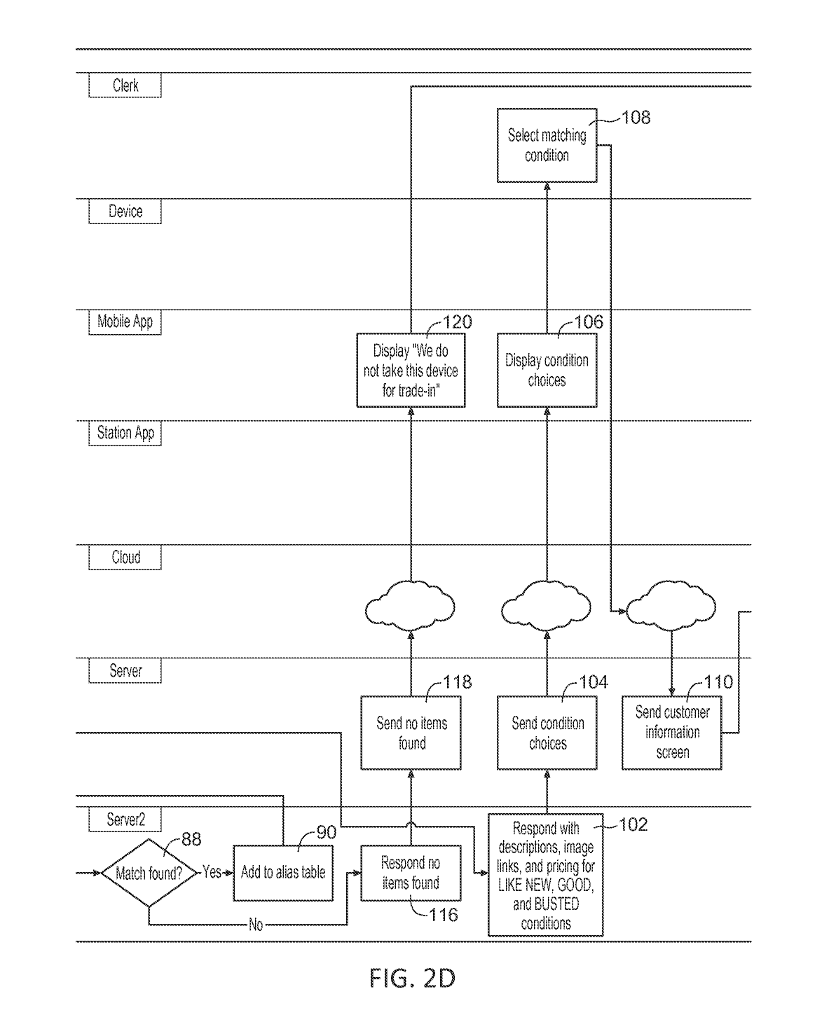

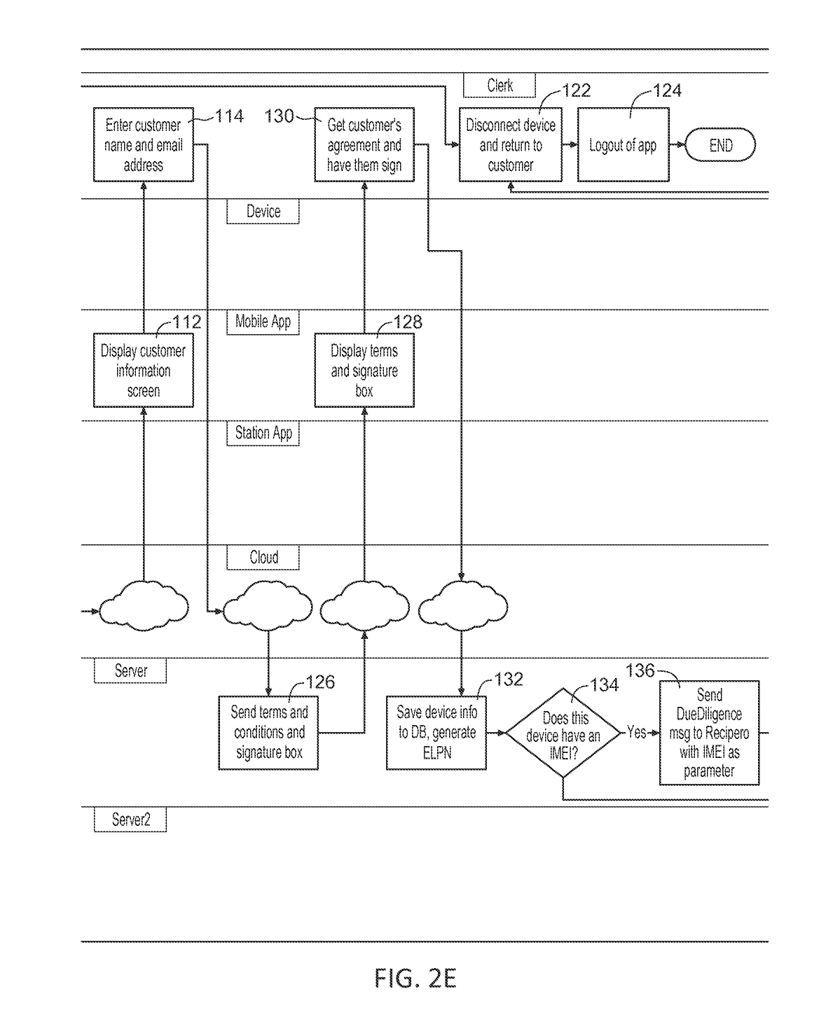

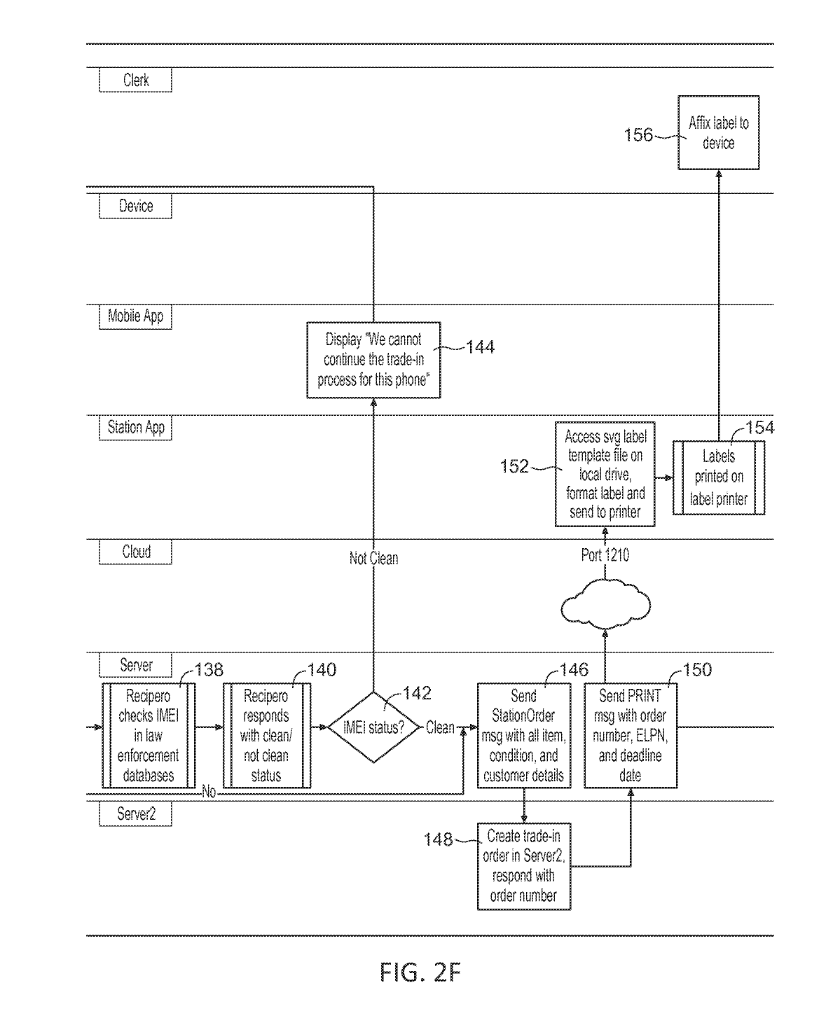

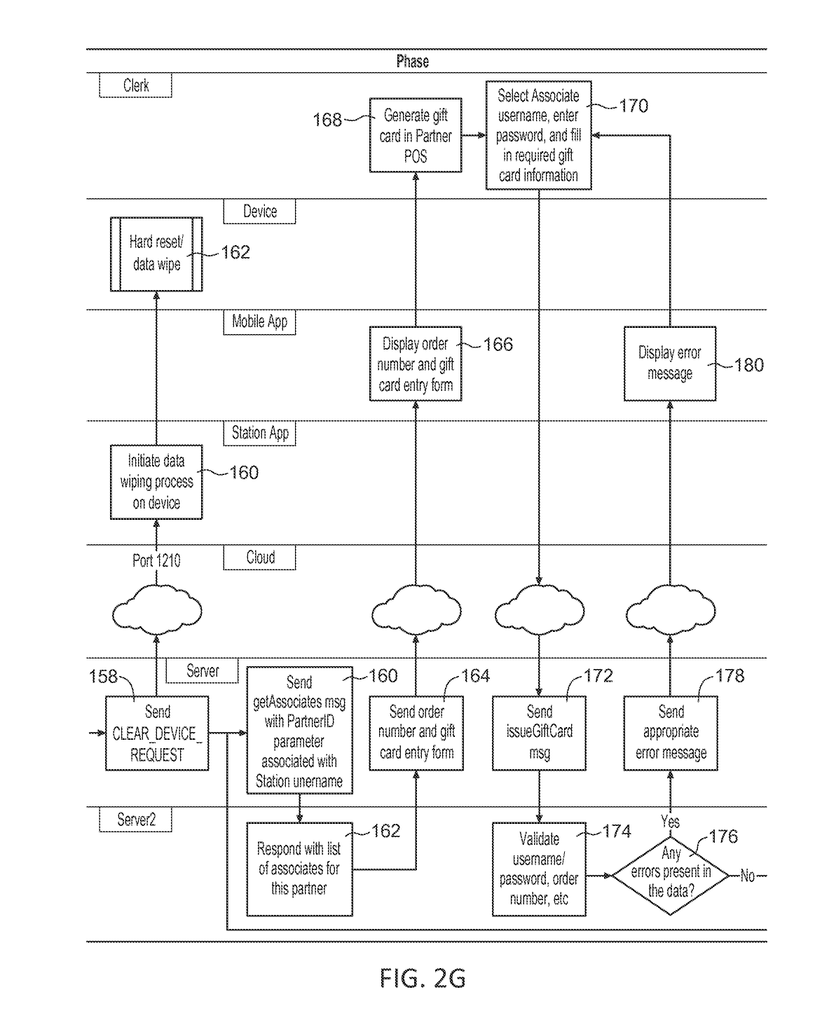

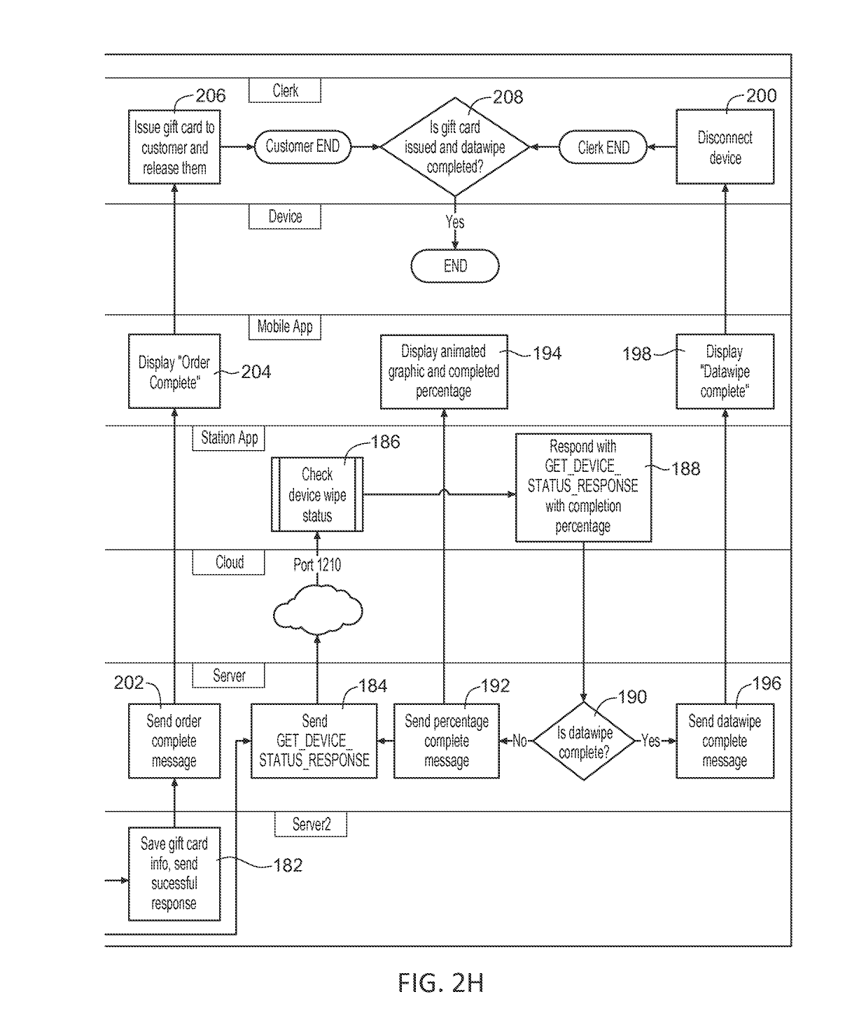

FIGS. 2A-2H are a flowchart operations performed by a retail device evaluation system implemented with a retail station of a preferred embodiment in the form of a tablet or special purpose retail station. The flowchart is separated vertically by the entity performing a particular operation, specifically, a clerk interacting with a retail station (app on a tablet/station), a device being traded in, a mobile app, the retail station app, cloud services, a server and a second server. The servers can be separate devices or a common server that performs multiple functions. The mobile app and retail station app can also be a single app, with the combined functions shown in FIGS. 2A-2H. In the preferred embodiments, the mobile app and retail station app are separate so that the mobile app can provide customized interfaces and front operation, and background operations can be provided by separate software or third party services that are provided with information messages and access to a connected device through the retail station. In the flowcharts of FIGS. 2A-2H, many of the sequences of events can be altered in variations of the preferred embodiment, as will be appreciated by artisans. As an example, the collection of signatures and customer agreement can be prior or after a value assessment is made. Other variations will be apparent to artisans.

In FIG. 2A, a clerk (retail representative assisting a person seeking to trade in an e-device) is presented 40 a login page (provided by the station app). This page can be customized to present information concerning a particular retail location through rendering pages with a particular look and feel, e.g. as a retailer specific skin. The mobile app sends 42 login information such as username, password, IP address to the server via internet connection (cloud). The server authenticates a user 44 and captures an IP address of the tablet/station. An inquiry to enumerate 46 connected devices is generated by the server through an assigned port, in this example Port 1210. The tablet/station responds by reading 48 connected device data, which each connected device provides 50 and the tablet/station (FIG. 2B) sends 52 a list of connected devices to the server, which checks 54 to determine if any devices are provided. If not, the enumerate device 46 (FIG. 2A) sequence is re-looped. When the list includes device(s), an information request is generated 56 (FIG. 2B) by the server to obtain device data and transmitted to the tablet/station that then requests 58 identification data from connected devices. Each device responds 60 with device identification information, e.g., the ESN (electronic serial number), IMEI (international mobile equipment identity) or MEID (mobile equipment identifier) data. This data is obtained by the tablet/station and sent 62 to the server.

The server checks 64 or grants access for checks by other software (such as via Internet connection and message exchange) for anti-theft protections and device locks. Preferred embodiments interface with commercially available software for conducing device lock checks. Examples include Futuredial, Pervacio and Blancco. This is another advantage of separating the mobil app and the tablet app, as the mobile app can control information exchange with one or more services, or change services, providing messages needed for checks without changing the interface presented at the retail location. Detection of such protection sends a guide 66 back to the tablet/station with step-by-step instructions for the clerk (with assistance of a mobile device owner/customer) to disable 68 the protection. The server and tablet prevent any further steps in this case, until the protection is disabled. For this reason, the clerk asks the tablet/station to refresh 70 the device check. This returns the server to the loop back to device detection 54. When no protection is revealed from the check 64, the server allows the tablet/station to display device details 72 which can be confirmed 74 by the clerk that is working with the tablet/station. Details can include, for example, Manufacturer, Part Number, Color, MEID, Serial Number, Model Name, Storage Capacity, Carrier, Locked or Unlocked Carrier Status, IMEI, Status of “Find my iPhone” or other security feature. A message is sent to the server 76 with the manufacturing part number. The server then conducts a look-up 78 on server2, which references or is a database to look up manufactured parts.

Server2 checks for a match 80 (FIG. 2C). If no match is found, an alias table is checked 82. The alias table preferably is a matrix in a database that maps many manufacturer part numbers to one master manufacturer part number that can be used in inventory systems. If no alias table match is found, the part number is parsed, such as by searching on a reducing portion of the part number, decrementing by one character each pass until a match is found, or the search gets down to one character. If a match is found through parsing 88 (FIG. 2D), then the information is added to the alias table 90. The alias table permits mapping of multiple manufacturer part numbers to a single type of device maintained as a catalog item by server2. With a match, the server2 provides 92 (FIG. 2C) a list of matching items. The server determines the number 94 of matching items. With multiple items listed, the tablet/station displays the list and the correct device ID can be selected 98 and is identified to the server. No selection is required when there is one match found 94. In either case, the server requests 100 applicable condition information from server2. Server2 responds with information 102, which can include many categories of information to check. For example, descriptions of conditions, images or links to images of example conditions, pricing for various conditions, and like information can be provided. The server then prepares guided choices 104 that are then displayed 106 on the tablet/station, allowing the clerk to select applicable conditions 108, which are returned to the server. The server then provides a customer identification screen 110 that is displayed 112 (FIG. 2E) on the tablet/station and customer information, such as name, email address, address and other contact information are input 114.

When server2 finds no match 116 (FIG. 2D) after alias searching and parsing, the server records this lack of match 118. In preferred embodiments some additional steps can be performed before a lack of match is recorded. In preferred embodiments, alias searching and parsing first searches for an exact model match using separate model parameters: model family, storage capacity, color and carrier. With a match on all four parameters, the part number is added to the alias table. With no match, a guided manual search can be conducted. For example, a retail clerk/sales associated is provided with a series of tree-based selections (eg. device type, manufacturer, model, capacity, carrier, etc) for them to visually identify and select the model. In this case of manual selection, there is preferably no addition to the alias table—to avoid manual error corruption of the table. When no match is recorded 118, the tablet/station displays a message 120 indicating that the particular device that could not be matched will not be exchanged for value, such as trade-in on another device, cash payment, or store credit. The clerk then disconnects the device 122 (FIG. 2E) and can optionally log out 124 of app if there are no other devices connected or additional devices to be connected.

With a device being processed after obtaining customer data 114 (FIG. 2E), the server prepares a terms and conditions sheet 126 specific to that device, which is displayed with a signature box by the tablet/station 128 and the customer signs the agreement 130 on the touch screen of a tablet or with a separately connected terminal for receiving signatures.

A procedure to check public databases for information regarding transferability, e.g. because of theft reports, is conducted. The server saves the device information and then generates a unique identifier (ELPN) 132 for that device that can be used to track the device and generate bar codes for shipping labels. The server checks for IMEI or other device ID information 134, to facility a look up for the transferability check. In the illustrated embodiment for simplicity of illustration, it will be assumed that IMEI is the parameter checked and one database that handles IMEI checks is consulted. The process can be repeated for other forms of device ID with other databases, or multiple databases can be checked for one or more particular types of device IDs. In this example, the IMEI due diligence data is sent to the Recipero® database service 136, but other services can be used. The server waits while Recipero® (or another database checks device transferability status 138 and receives a response 140 with a status of clean or not clean. When the status is not clean upon check of the message 142 by the server, the tablet/station provides a message 144 that acceptance of the device for exchange of value will not be permitted, and then the clerk proceeds with the disconnection of the device 122 (FIG. 2E).

With a clean status check 142 (FIG. 2F), the server generates an order request 146 and server2 creates an order 148 and responds with the order number. The order request 146 includes value information based upon conditions previously obtained, and can be categorical (e.g., LIKE NEW, GOOD, FAIR and POOR) to look up a value of the device. Additional conditions, values and checks are possible, and the value may be assessed with reference to information obtained from proprietary formulaic data or data that is available through internet sources. The server generates a print message 150 and also deadline data and other information needed to complete the transaction. The tablet/station receives a print label template 152, which will include bar code tracking information (a unique ELPN assigned serial number) and shipping information, e.g., address and carrier and prints a shipping label and a device label 154. Alternatively, the retail location can have pre-printed shipping labels to ship batches of devices, and the each device is labelled directly with a tracking label that will allow the server to obtain all information about the device and transaction that has been collected. The clerk affixes a device label 156 to the device. Other information that can be included in a separate print-out, label or stored for later reference can include Trade-in Order Number, Model Number, IMEI, unique identifier for a unit in server (ELPN), Barcode of ELPN, and Deadline date to ship the device to entity that will handle re-sale and/or refurbishing of the device and provide exchange of value to the retailer.

The server also commences device wiping or resetting after the print message 150. A clear device request 158 (FIG. 2G) has the tablet/station initiate 160 a data wipe or reset 162 by the device. This may alternatively be another type of operation instead of a wipe, for example, a restore feature can also be provided as part of the reset that restores device settings to factory settings. This preferably includes removing non-private data that was not present at the time of original sale and restoring missing items that were present at the time of initial sale. The tablet/station preferably displays a progress indication during the data wipe indication a percentage progress of completion.

The server commences other operations while data wipe/reset is being conducted. The server can request to obtain 160 a list of associates (individuals at a retailer) and server2 responds 162 with a list of associate for the partner (retailer) associate with the particular tablet/station. The server generates and order number and form for receiving value, e.g., gift card form 164, and the tablet/station 166 displays the form and the order number. The tablet can communicate with the retailer's point of sale system, which can generate a gift card 168. Preferably, additional steps verify that a gift card (or a coupon, or a cash value card, or another type of value) should be issued to the customer. The clerk/sales associate can enter additional data 170 concerning gift card validation, including login information about the sales associate, passwords and information about the particular gift card, such as information about the person receiving the gift card. This data cause the server to produce a gift card message 172 with relevant data the information received and server2 validates 174 the data, such as user/password/order number. If there are errors upon a check 176, an error message is sent 178 and the tablet/station displays an error message 180. Information must be entered or corrected 170 in response by the clerk/sales associate.

With no errors from the check 176, server2 saves information about the gift card transaction and issues a success message 182. The gift card processing steps are preferably conducted while the data reset and wipe is progressing. The server issues a message to check the device status 184 and the tablet/station checks the device status 186 and responds 188 with a percentage of completion. The server checks to see if the wipe is complete 190. If not, it generates a percentage completion message 192, the status loop continues through the device status request 184 and the tablet displays a graphical indication 194 of completion status. If the wipe is complete, the server generates a wipe completion message 196 and a completion indication is displayed 198 by the tablet/station and the clerk/sales associate can then physically disconnect the device 200 and physically package it for sending to the entity that is handling it alone or with a group of devices that have been labeled for processing. The gift card issue message 182 can be commensurate, before or after the data wipe, and the server sends an order complete message 202 that is displayed by the tablet/station 204 and allow the clear/point of sale system to issue a gift card 206. Cash or other value is also possible, in which case the tablet/station provides a recommendation of value to be given. This ends the process with the clerk checking that the gift card or other value has been issued and the data wipe is complete 208, as the processes may complete at different times.

With reference again to FIG. 2A, additional devices can be connected via a USB or other cable and adapter to the tablet/station. The tablet/station tries to connect 212 and then checks the operating system 214, e.g. Android or iOS. If Android, the device is placed into developer mode 216 and if iOS, the device is asked to respond to trust the tablet/station 218, Processing then continues as described, beginning with the log in to the station app 40.

The particular preferred embodiment of FIGS. 2A-2H is executable via a tablet app acting as a station or a specially configured retail station, as discussed above. The particular preferred server arrangement and separation of tasks can be combined, centralized, distributed, etc., in different manners in modified embodiments. In the particular preferred embodiments the separation/distribution of tasks, including a separation of apps on the tablet with the mobile app and the tablet/station app. The preferred distribution provides some advantages. The server in the preferred embodiment provides web-based interface screens served to the clerks browser, Android, Microsoft Surface or iOS app, and communicates with the tablet/station app. The server2 serves as a go-between for the server and server2 with several exposed APIs. It also provides trade-in values and images, accepts trade-in orders, and validates and records payment of a gift card to customer. The mobile app and tablet app can be combined by preferred embodiments. Preferred embodiments separate the apps as the tablet app can then better perform functions of interacting with local devices through ports such as USB ports (for connecting devices and printer) and provide custom interfaces for different retail operations while the work tasks of the tablet app can remain the same. This also permits the use of different services that can provide services such as the data wipe or device ID when granted access by the retail station without altering a particular mobile app that provides custom skins or looks at a particular retail location. The tablet app can run as a server, accepting API messages to perform operations such as identifying device details and data wiping the device, and is advantageous for certain operation systems, and particularly those use with Microsoft Surface® devices. The mobile app can be realized with programming of a webkit browser used on iPad (or another tablet) to login to the server and perform trade-in and wipe operations. In this case, the iPad can serve as the I/O device for another station, or be configured on its own to all perform the tablet apps.

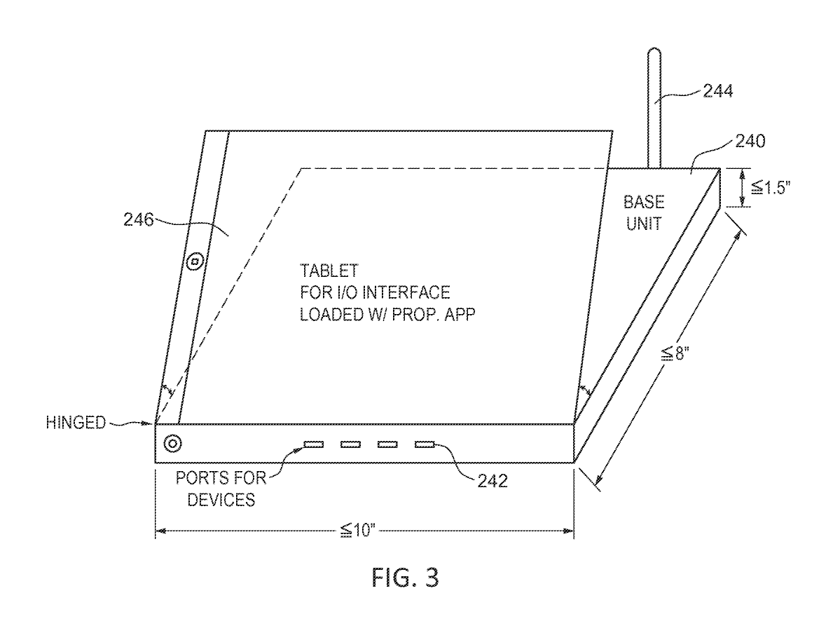

The tablet can be a stand-alone device, as described above, and fully implement preferred methods of the invention. Other preferred embodiments include a special purpose retail station, as shown in FIG. 3 with exemplary preferred dimensions. The retail station device includes a base 240 that provides a plurality of ports 242, e.g. USB ports but also can include device specific ports, micro USB, and Lightning connectors, and also provide power for charging a connected device. An antenna 244 is provided. A tablet 246 is docked via a hinged connection, and includes an app to cooperate with the base electronics. In alternate embodiments, the tablet 246 is an integrally connected touch screen display. An example base 240 has a small form factor of 240 mm×150 mm×48 mm, and includes active, fanless cooling. These dimensions provide a convenient retail countertop package.

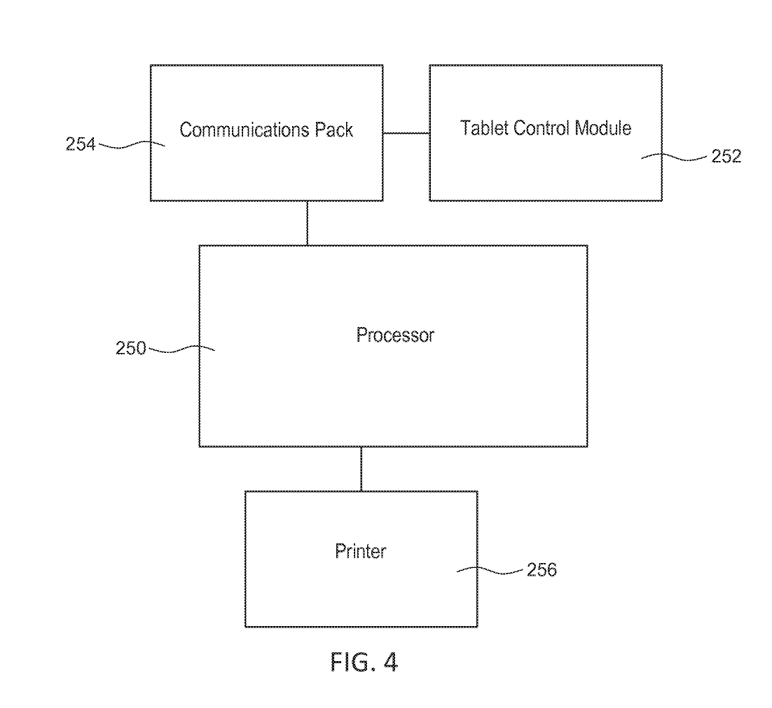

FIG. 4 illustrates preferred features of a system using a station such as the station in FIG. 3. In preferred embodiments, electronics and hardware in the base 240 include a processor 250, a tablet control module 252, and a communications pack 254. The system also preferably includes or connects to a printer 256, capable of printing labels generated by the system during processing of mobile device. The processor 250 in preferred embodiments provides support for 2.5-inch drives, into the small form factor of the base 240, and preferably includes a 4th generation Intel® Core™ i3 processor or later future advanced generation, which supports four USB 3.0 ports, 2 internal USB 2.0 ports, an infrared sensor, a headphone/microphone jack, Mini HDMI*, and Mini DisplayPort* video interfaces, Onboard Wi-Fi ABGN technology, Bluetooth capability and a micro SD update port allowing deployment upgrade options. Additional preferred features include embedded WWAN, touch panel and or internal printer, and kiosk mode capability with wireless digital signage feature.

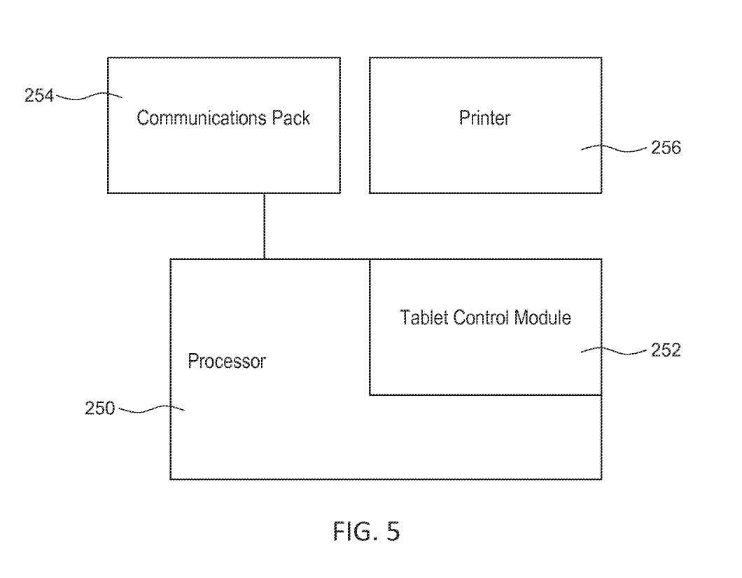

FIG. 5 schematically illustrates a similar embodiment to the FIG. 4 embodiment, where the tablet control module 252 is implemented with the processor of a tablet, i.e., the tablet acts as a retail station. Preferred embodiments in accordance with FIG. 5 include a self-contained tablet computer with a tablet form factor, 4th generation Intel® Core™ i3 processor or later generation, 1 USB 3.0 port for smartphone connectivity, a headphone/microphone jack, and Mini DisplayPort* video interface, Onboard Wi-Fi A,A/C,B,G,N technology, Bluetooth capability and a micro SD update port allowing deployment upgrade options in the field.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A retail station for electronic device evaluation, comprising:
a connection interface that supports connection to at least one type of electronic device;
evaluation software for evaluating or granting access by other software to evaluate the electronic device by querying the electronic device to collect information determine its status and value for a trade-in transaction;
guidance software for generating information to aid a customer service representative in processing a trade-in transaction of the electronic device; and
data collection software for collecting data or granting access by other software to collect data to support a trade-in transaction.

2. The station according to claim 1, comprising a base that provides said connection interface and is dimensioned as countertop device for a retail counter.

3. The station according to claim 2, wherein the guidance software is presented to a device that is separate from the countertop device, and the countertop device includes the connection interface.

4. The station according to claim 1, further comprising software for erasing or granting access to other software to erase an electronic device, transferring data and apps to and from or granting access to other software to transfer data and apps to and from the electronic device, and/or restoring the device to a factory state.

5. The station according to claim 1, wherein the evaluation software or other software checks an external device database for specific electronic device identification information and/or for value information.

6. The station according to claim 1, comprising a tablet computer that provides said connection interface.

7. The station according to claim 1, comprising a plurality of connection interfaces to connect a plurality of electronic devices.

8. The station according to claim 1, further comprising a charger for charging a connected electronic device at a maximum amperage tolerated by the electronic device.

9. A method for identifying, assessing and facilitating trade in of electronic devices, the method comprising:
connecting an electronic device to a station in a retail environment;
checking for anti-theft feature activation on the electronic device and displaying on a display instructions for shutting down any activated anti-theft features;
obtaining unique electronic device identification data and comparing the device identification data to database information of unclean device identifications;
displaying on the display an indication that the electronic device can't be processed if said obtaining finds a unclean device status, and otherwise,
guiding collection of device conditions through the display and receiving device conditions;
providing valuation information through the display based upon received device conditions.

10. The method of claim 9, further comprising wiping data from the electronic device.

11. The method of claim 10, further comprising displaying an acceptance screen upon the display and obtaining and storing transaction confirmation data.

12. The method of claim 10, further comprising transferring data from the electronic device to another electronic device.

13. The method of claim 10, further comprising obtaining biometric data.

14. The method of claim 13, wherein said obtaining biometric data comprises obtaining data sufficient to meet requirements of applicable Second Hand Dealer laws.

15. The method of claim 9, implemented upon a retail station computer device running software that interfaces with the electronic device and accesses a server over the Internet.

16. The method of claim 15, wherein the retail station computer device is at a retail location and the server is administered by a party that provides the retail station and support to the retail location in exchange for value.

17. The method of claim 9, further comprising generating gift card information to the station and storing records regarding the gift card information.

18. The method of claim 9, further comprising generating a unique device identification and printing a label through the station to apply to the electronic device for tracking of the electronic device.

19. The method of claim 9, wherein said displaying comprises providing images of the type of electronic device and information on how to evaluate the electronic device.

20. A system for facilitating trade in of electronic devices, the system comprising:
a retail station at a retail location with a connection capability to connect to a plurality of types of electronic devices;
a display associated with the retail station for displaying guidance and instructions during a trade in transaction including valuation and exchange information;
a label printer associated with the retail station for printing labels to affix to electronic devices or packaging of electronic devices for processing by a third party;
a server associated with the third party configured to communicate with the retail station, obtain device information from a device connected to the retail station, provide the guidance and instructions based upon a type of device that is connected to the retail station, check the clean or unclean status of the device connected to the retail station, provide the valuation and exchange information based upon an assessed device condition and type, and direct printing of a label with a unique device identification for processing by the third party when the retail location sends an electronic device to the third party.
